(19) United States
(12) Patent Application Publication
(10) Pub. No.: US 2016/0279881 A1
(43) Pub. Date: Sep. 29, 2016

(54) THREE-DIMENSIONAL MODELING APPARATUS

(71) Applicant: SEIKO EPSON CORPORATION, Tokyo (JP)

(72) Inventor: Eiji OKAMOTO, Matsumoto (JP)

(21) Appl. No.: 15/073,792

(22) Filed: Mar. 18, 2016

(30) Foreign Application Priority Data
Mar. 27, 2015 (JP) 2015-065916
Mar. 27, 2015 (JP) 2015-065917

(51) Int. Cl. B29C 67/00

(52) U.S. Cl. CPC B29C 67/0088; B29C 67/0059; B33Y 30/00

(57) ABSTRACT

The three-dimensional modeling apparatus includes a head unit for modeling the object by discharging a liquid that is to be a material of the object into each unit grille, and a control unit for controlling the head unit. In the case of discharging a forming liquid into a first unit grille and discharging a supporting liquid into a second unit grille adjacent to the first unit grille in the X direction or the Y direction, the control unit controls the head unit so as to discharge the forming liquid into the first unit grille in an amount that is larger than or equal to the spatial volume of the first unit grille, and discharge the supporting liquid into the second unit grille in an amount that is smaller than the spatial volume of the second unit grille.

### BACKGROUND

1. Technical Field

The present invention relates to a three-dimensional modeling apparatus.

2. Related Art

In recent years, three-dimensional modeling apparatuses that adopt a printing technique have been attracting attention. For example, in the three-dimensional modeling apparatuses described in JP-A-06-218712, JP-A-2005-67138, and JP-A-2010-58519, an inkjet technique generally used in a printing technique is adopted. With three-dimensional modeling apparatuses that adopt the inkjet technique, a three-dimensional object is modeled by performing, over a number of layers in the height direction (Z direction), a step of discharging a liquid having curability and forming a cross sectional body for one layer that lies in the horizontal direction (XY directions).

JP-A-06-218712, JP-A-2005-67138, and JP-A-2010-58519 are examples of related art.

An inkjet type of three-dimensional modeling apparatus forms a cross sectional body by discharging a liquid to form dots at designated coordinates at a predetermined modeling resolution. Therefore, for example, a level difference that corresponds to the lamination thickness is formed on an outline inclined with respect to the XY plane, and a contour line-like pattern is formed in some cases. Therefore, in the three-dimensional modeling apparatus for forming a three-dimensional object by discharging a liquid, a technique that can suppress the formation of a level difference in the object being modeled is demanded.

### SUMMARY

An advantage of some aspects of the invention is to solve at least some of the above-described problems, and the invention can be achieved as the following modes.

[1] According to one mode of the invention, a three-dimensional modeling apparatus for modeling a three-dimensional object by laminating a plurality of cross sectional bodies in a lamination direction is provided. This three-dimensional modeling apparatus includes: a head unit for modeling the object by discharging a liquid that is to be a material of the object into each unit grille that is defined in accordance with a modeling resolution of the cross sectional body in an X direction, a modeling resolution of the cross sectional body in a Y direction, and a lamination interval of the cross sectional body in the lamination direction; and a control unit for controlling the head unit. The head unit is capable of discharging, into the unit grilles, at least one of a forming liquid for forming the object and a supporting liquid for supporting the object. Regarding a surface of the object inclined with respect to an XY plane, in the case of discharging the forming liquid into a first unit grille and discharging the supporting liquid into a second unit grille adjacent to the first unit grille in the X direction or the Y direction, the control unit controls the head unit so as to (1) perform first slope formation processing in which the forming liquid is discharged into the first unit grille in an amount greater than or equal to a spatial volume of the first unit grille, and the supporting liquid is discharged into the second unit grille in an amount smaller than a spatial volume of the second unit grille, or (2) perform second slope formation processing in which the forming liquid is discharged into the first unit grille in an amount smaller than the spatial volume of the first unit grille, and the supporting liquid is discharged into the second unit grille in an amount greater than or equal to the spatial volume of the second unit grille.

With the three-dimensional modeling apparatus of such a mode, when forming a surface of the object that is inclined in the X direction or the Y direction, the forming liquid can be caused to flow from the first unit grille into the second unit grille, or the supporting liquid can be caused to flow from the second unit grille into the first unit grille, and therefore it is possible to form a slope across the first unit grille and the second unit grille. Thus it is possible to suppress the formation of a level difference in the object being modeled.

[2] In the three-dimensional modeling apparatus of the above mode, in the case where the first unit grille and the second unit grille are on the lamination direction side of the object, the control unit may execute the first slope formation processing, and in the case where the first unit grille and the second unit grille are on the side in a direction opposite to the lamination direction of the object, the control unit may execute the second slope formation processing.

With the three-dimensional modeling apparatus of such a mode, a slope can be appropriately formed in accordance with whether the portion including the first unit grille and the second unit grille is on the lamination direction side of the object or on the opposite side.

[3] In the three-dimensional modeling apparatus of the above mode, the shape of the object may be indicated by polygon data that is a set of polygons, and in the case where a first polygon passes through the first unit grille and the second unit grille, an amount of the forming liquid to be discharged into the first unit grille, and an amount of the supporting liquid to be discharged into the second unit grille may be amounts individually determined in accordance with residual volumes of the first unit grille and the second unit grille in the case where the first unit grille and the second unit grille are cut through by the first polygon.

With the three-dimensional modeling apparatus of such a mode, the amount of supporting liquid and the amount of forming liquid are determined in accordance with the positional relationship between the polygon and the first unit grille and the second unit grille, and thus it is possible to more effectively suppress the formation of a level difference.

[4] In the three-dimensional modeling apparatus of the above mode, the shape of the object may be indicated by polygon data that is a set of polygons, and in the case where a second polygon passes through one of the first unit grille and the second unit grille, an amount of the forming liquid to be discharged into the first unit grille, and an amount of the supporting liquid to be discharged into the second unit grille may be amounts determined in accordance with a residual volume of a unit grille that the second polygon passes through, out of the first unit grille and the second unit grille, in the case of being cut through by the second polygon.

With the three-dimensional modeling apparatus of such a mode, the amount of supporting liquid and the amount of forming liquid are determined in accordance with the positional relationship between the polygon and the first unit grille or the second unit grille, and therefore it is possible to more effectively suppress the formation of a level difference.

[5] In the three-dimensional modeling apparatus of the above mode, in the first slope formation processing and the second slope formation processing, the total of an amount of the forming liquid to be discharged into the first unit grille and an amount of the supporting liquid to be discharged into the second unit grille may be the same as the total of the spatial volume of the first unit grille and the spatial volume of the second unit grille.

With the three-dimensional modeling apparatus of such a mode, it is possible to unifomize the volume of the first unit grille and the volume of the second unit grille in the modeled object, and therefore it is possible to improve the modeling quality of the object.

[6] According to one mode of the invention, a three-dimensional modeling apparatus for modeling a three-dimensional object by laminating a plurality of cross sectional bodies in a lamination direction is provided. This three-dimensional modeling apparatus includes: a head unit for modeling the object by discharging a liquid that is to be a material of the object into each unit grille that is defined in accordance with a modeling resolution of the cross sectional body in an X direction, a modeling resolution of the cross sectional body in a Y direction, and a lamination interval of the cross sectional body in the lamination direction; and a control unit for controlling the head unit. The head unit may be capable of discharging a forming liquid for forming the object and a supporting liquid for supporting the object into one unit grille. The control unit may gradually increase or decrease at least one of an amount of the forming liquid and an amount of the supporting liquid to be discharged into each of a plurality of unit grilles consecutively aligned along an XY plane in accordance with positions of the unit grilles along the XY plane, thereby modeling a slope of the object that is inclined with respect to the XY plane across the unit grilles.

With the three-dimensional modeling apparatus of such a mode, the amounts of forming liquid and supporting liquid to be discharged into unit grilles consecutively aligned along the XY plane can be gradually decreased or increased in accordance with the positions of those unit grilles, and thus it is possible to suppress the formation of an obvious level difference in the object that is modeled.

[7] In the three-dimensional modeling apparatus of the above mode, the shape of the object is indicated by polygon data that is a set of polygons, and each of the unit grilles may be associated with at least one of an amount of the forming liquid and an amount of the supporting liquid to be discharged into the unit grille in accordance with the residual volume of the unit grille in the case of being cut through by the polygon.

With the three-dimensional modeling apparatus of such a mode, it is possible to suppress the formation of an obvious level difference in the three-dimensional object indicated by polygon data.

[8] In the three-dimensional modeling apparatus of the above mode, in the case where the slope is on the lamination direction side of the object, amounts of the supporting liquid to be discharged into the plurality of unit grilles may be fixed amounts.

With the three-dimensional modeling apparatus of such a mode, if the slope is on the lamination direction side of the object, it is not necessary to adjust the amount of the supporting liquid, and thus the processing load can be reduced.

[9] In the three-dimensional modeling apparatus of the above mode, in the case where the slope is on the side in a direction opposite to the lamination direction of the object, amounts of the forming liquid to be discharged into the plurality of unit grilles may be fixed amounts.

With the three-dimensional modeling apparatus of such a mode, if the slope is on the side in the direction opposite to the lamination direction of the object, it is not necessary to adjust the amount of forming liquid, and thus the processing load can be reduced.

[10] The three-dimensional modeling apparatus of the above mode may further include a cutting device for uniformizing the height of the cross sectional body.

With the three-dimensional modeling apparatus of such a mode, even in the case where the amounts of supporting liquid and forming liquid are not adjusted, the height of the cross sectional body can be uniformized, and thus the modeling quality of the object can be improved.

The invention can also be achieved in various modes other than the modes as a three-dimensional modeling apparatus. For example, the invention can be achieved as a manufacturing method for manufacturing a three-dimensional object, a computer program for modeling a three-dimensional object under the control of the three-dimensional modeling apparatus, a non-transitory tangible recording medium on which the computer program is recorded, or the like.

### BRIEF DESCRIPTION OF THE DRAWINGS

The invention will be described with reference to the accompanying drawings, wherein like numbers reference like elements.

FIG. 1 is an explanatory diagram showing a schematic configuration of a three-dimensional modeling apparatus in a first embodiment.

FIG. 2 is a flowchart of three-dimensional modeling processing.

FIG. 3 is a detailed flowchart of gradation value adjustment processing.

FIG. 4 is a diagram for describing the processing content of first gentle slope processing.

FIG. 5 is a diagram for describing the processing content of first steep slope processing.

FIG. 6 is a diagram for describing the processing content of second gentle slope processing.

FIG. 7 is a diagram for describing the processing content of second steep slope processing.

FIG. 8 is a flowchart of data conversion processing in a second embodiment.

FIG. 9 is a flowchart of data conversion processing in a third embodiment.

FIG. 10 is an explanatory view showing a schematic configuration of a three-dimensional modeling apparatus in a fourth embodiment.

FIG. 11 is a diagram for describing the processing content of first gentle slope processing in a fifth embodiment.

FIG. 12 is a diagram for describing the processing content of second gentle slope processing in the fifth embodiment.

FIG. 13 is a diagram for describing the processing content of first gentle slope processing in a sixth embodiment.

FIG. 14 is a diagram for describing the processing content of second gentle slope processing in the sixth embodiment.

### DESCRIPTION OF EXEMPLARY EMBODIMENTS

### A. First Embodiment

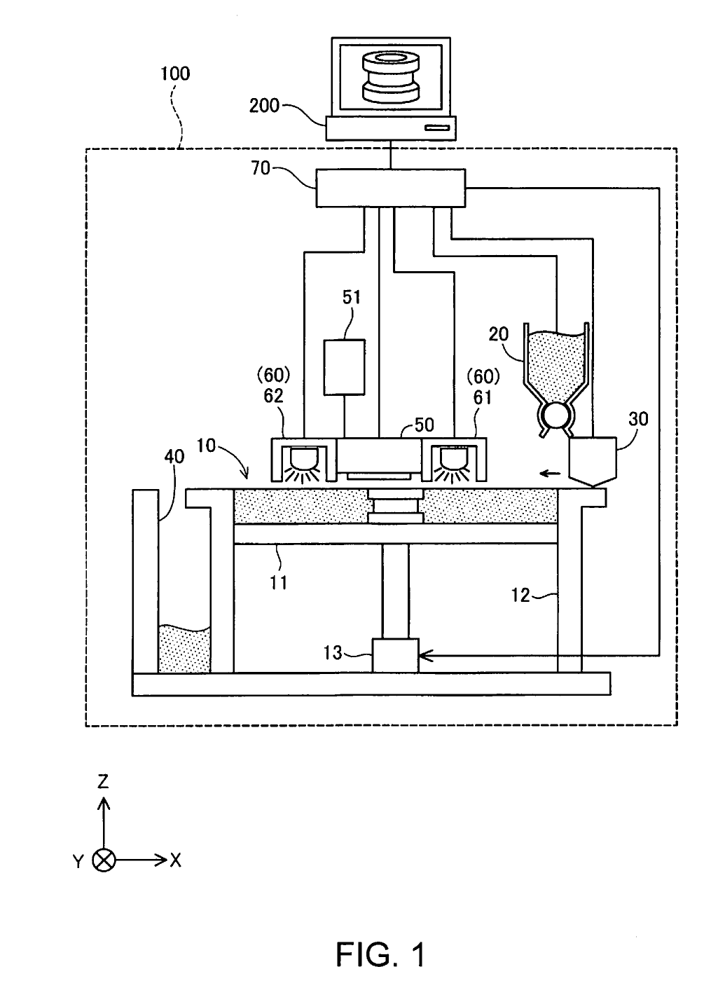

FIG. 1 is an explanatory diagram showing the schematic configuration of a three-dimensional modeling apparatus in a first embodiment of the invention. A three-dimensional modeling apparatus 100 is provided with a modeling unit 10, a powder supply unit 20, a flattening mechanism 30, a powder collecting unit 40, a head unit 50, a curing energy applying unit 60, and a control unit 70. A computer 200 is connected to the control unit 70. The three-dimensional modeling apparatus 100 and the computer 200 can be collectively regarded as a three-dimensional modeling apparatus in a broad sense. In FIG. 1, an X direction, a Y direction and a Z direction that intersect orthogonally to one another are shown. The Z direction is a direction along the vertical direction, and the X direction is a direction along the horizontal direction. The Y direction is a direction along a direction perpendicular to the Z direction and the X direction. In the following description, assume that the +Z direction side is “upper side” or “upper direction”, and the −Z direction side is “lower side” or “lower direction”. In addition, the +Z direction is also referred to as “lamination direction”, and the −Z direction is also referred to as “direction opposite to the lamination direction”.

The modeling unit 10 is a tank-shaped structure in which a three-dimensional object is modeled. The modeling unit 10 is provided with a modeling stage 11 that is flat and lies in an XY direction, a frame body 12 surrounding the periphery of the modeling stage 11 and erect in the Z direction, and an actuator 13 for moving the modeling stage 11 in the Z direction. The modeling stage 11 moves in the Z direction in the frame body 12 by the control unit 70 controlling the operations of the actuator 13.

The powder supply unit 20 is an apparatus for supplying powder into the modeling unit 10. The powder supply unit 20 is constituted by a hopper or a dispenser, for example.

The flattening mechanism 30 is a mechanism for flattening the powder supplied into the modeling unit 10 or on the frame body 12 and forming a powder layer on the modeling stage 11 by moving over the upper surface of the modeling unit 10 in the horizontal direction (XY directions). The flattening mechanism 30 is constituted by a squeegee or a roller, for example. The powder pushed out from the modeling unit 10 by the flattening mechanism 30 is discharged into the powder collecting unit 40 provided adjacent to the modeling unit 10.

The three-dimensional modeling apparatus 100 in the first embodiment uses a liquid having curability (hereinafter, referred to as “curable liquid”) and the above powder as materials of a three-dimensional object. A mixture of a liquid resin material that is mainly composed of monomers and oligomers to which monomers are bonded, and a polymerization initiator that enters an excited state when irradiated with ultraviolet light, and acts on the monomers or the oligomers so as to start polymerization is used as a curable liquid. In addition, as the monomers of the resin material, relatively low molecular weight monomers are selected, and furthermore, the number of monomers included in one oligomer of the resin material is adjusted to be about a few molecules such that the curable liquid has a low viscosity that allows droplets to be discharged from the head unit 50. This curable liquid has a property of quickly curing and becoming a solid when the curable liquid is irradiated with ultraviolet light and the polymerization initiator is in an excited state, the monomers polymerize with one another and grow into oligomers, and the oligomers also polymerize with one another in places.

In this embodiment, the three-dimensional modeling apparatus 100 uses forming ink (forming liquid) and supporting ink (supporting liquid) as curable liquids. The forming ink is a curable liquid for forming a three-dimensional object. On the other hand, the supporting ink is a curable liquid for supporting the three-dimensional object formed using the forming ink. The supporting ink is a liquid that undergoes curing due to curing energy that is equivalent to curing energy that causes the curable liquid to cure, and is a curable liquid that dissolves due to being exposed to water or a predetermined solution after curing, and can be easily removed.

In this embodiment, powder particles on the surface of which a polymerization initiator of a different type from that contained in the curable liquid are attached is used as the powder. The polymerization initiator attached to the surface of the powder particles has a property of acting on the monomers or the oligomers so as to start polymerization when coming into contact with the curable liquid. Therefore, when the curable liquid is supplied to the powder in the modeling unit 10, the curable liquid permeates into the powder, comes into contact with the polymerization initiator on the surface of the powder particles, and cures. As a result, in a portion onto which the curable liquid is discharged, powder particles are coupled with one another by the curable liquid that has cured. Note that in the case of using, as the powder, powder particles having a polymerization initiator attached to the surface thereof, a curable liquid that does not contain a polymerization initiator can also be used.

The head unit 50 is an apparatus that receives supply of the above-described curable liquid (forming ink and supporting ink) from a tank 51 connected to the head unit 50 and discharges, in the Z direction, the curable liquid onto the powder layer in the modeling unit 10. The head unit 50 can move in the X direction and the Y direction with respect to the three-dimensional object that is modeled in the modeling unit 10. In addition, the head unit 50 can move in the Z direction relative to the three-dimensional object, by the modeling stage 11 inside of the modeling unit 10 moving in the Z direction.

The head unit 50 of this embodiment is a so-called piezoelectric drive type droplet discharging head. By filling a pressure chamber having a minute nozzle hole with the curable liquid and bending the sidewall of the pressure chamber using a piezoelectric element, the piezoelectric drive type droplet discharge head can discharge, as droplets, a curable liquid with a volume corresponding to the reduced volume of the pressure chamber. The control unit 70 that is described later can adjust the amount of the curable liquid per droplet to be discharged from the head unit 50 by controlling the waveform of the voltage to be applied to the piezoelectric element. The head unit 50 is provided with a nozzle hole for discharging the forming ink and a nozzle hole for discharging the supporting ink, and can discharge the forming ink the supporting ink individually.

The curing energy applying unit 60 is an apparatus for applying energy for curing the curable liquid discharged from the head unit 50. In this embodiment, the curing energy applying unit 60 is constituted by a main curing light emitting apparatus 61 and a provisional curing light emitting apparatus 62 that are arranged so as to sandwich the head unit 50 in the X direction. When the head unit 50 is moved, the curing energy applying unit 60 also moves with the head unit 50. Ultraviolet rays as curing energy for curing the curable liquid are emitted from the main curing light emitting apparatus 61 and the provisional curing light emitting apparatus 62. The provisional curing light emitting apparatus 62 is used for performing provisional curing to fix the discharged curable liquid at the landing position thereof. The main curing light emitting apparatus 61 is used for completely curing the curable liquid after provisional curing. In this embodiment, the head unit 50 discharges the curable liquid while moving in the +X direction. Therefore, immediately after the curable liquid is discharged, provisional curing is performed by the provisional curing light emitting apparatus 62. After the head unit 50 reaches the end in the +X direction, the head unit 50 moves in the −X direction, and the main curing light emitting apparatus 61 then performs main curing on the curable liquid that underwent provisional curing. The energy of the ultraviolet rays emitted from the provisional curing light emitting apparatus 62 is 20 to 30% of the energy of the ultraviolet rays emitted from the main curing light emitting apparatus 61, for example.

The control unit 70 is provided with a CPU and a memory. The CPU has a function of modeling a three-dimensional object by controlling the actuator 13, the powder supply unit 20, the flattening mechanism 30, the head unit 50 and the curing energy applying unit 60 by loading a computer program stored in the memory or a recording medium to the memory and executing the program.

Functions achieved by the CPU provided in the control unit 70 include a function of controlling the head unit 50 to perform first slope formation processing or perform second slope formation processing on a surface of a three-dimensional object that is inclined with respect to the XY plane of the three-dimensional object to be modeled, in the case of discharging the forming liquid (forming ink) into a first unit grille that is a minimum unit for the modeling and discharging the supporting liquid (supporting ink) into a second unit grille adjacent to the first unit grille in the X direction or the Y direction.

The first slope formation processing is processing for forming a slope on the surface of the object by discharging the forming ink into the first unit grille in an amount greater than or equal to the spatial volume of the first unit grille, and discharging the supporting ink into the second unit grille in an amount less than the spatial volume of the second unit grille.

The second slope formation processing is processing for forming a slope on the surface of the object by discharging the forming ink into the first unit grille in an amount less than the spatial volume of the first unit grille, and discharging the supporting ink into the second unit grille in an amount greater than or equal to the spatial volume of the second unit grille.

A “unit grille” is a grille having a minimum volume that corresponds to the modeling resolution in the XY direction and the lamination interval in the Z direction of a cross sectional body constituting the three-dimensional object. The unit grille is also referred to as a voxel. Detailed description regarding the first slope formation processing and the second slope formation processing will be given later. The functions of the control unit 70 may be achieved by an electronic circuit.

A method for modeling (manufacturing) a three-dimensional object using the three-dimensional modeling apparatus 100 (FIG. 1) will be briefly described below. The computer 200 first slices three-dimensional data indicating the shape of the three-dimensional object in accordance with the modeling resolution (lamination pitch) in the Z direction, and generates a plurality of pieces of cross section data in the XY directions. This cross section data has predetermined modeling resolutions in the X direction and the Y direction, and is represented by two-dimensional bitmap data in which a gradation value is stored for each element. The gradation value stored for each element indicates the amount of curable liquid to be discharged at an XY coordinate corresponding to the element. That is, in this embodiment, bitmap data designates, for the control unit 70 of the three-dimensional modeling apparatus 100, a coordinate at which the curable liquid is to be discharged and the amount of curable liquid to be discharged.

Upon acquiring the cross section data from the computer 200, the control unit 70 of the three-dimensional modeling apparatus 100 forms a powder layer in the modeling unit 10 by controlling the powder supply unit 20 and the flattening mechanism 30. The control unit 70 then drives the head unit 50 so as to discharge the curable liquid onto the powder layer in accordance with the cross section data, subsequently controls the curing energy applying unit 60 so as to emit ultraviolet light toward the discharged curable liquid at a predetermined timing, and performs provisional curing and main curing. The curable liquid then cures due to the ultraviolet light, powder particles are coupled with one another, and a cross sectional body corresponding to cross section data for one layer is formed in the modeling unit 10. When the cross sectional body for one layer is formed in this manner, the control unit 70 drives the actuator 13 so as to lower the modeling stage 11 in the Z direction for a lamination pitch that is in accordance with a modeling resolution in the Z direction. When the modeling stage 11 has been lowered, the control unit 70 forms a new powder layer on the cross sectional body that has already been formed on the modeling stage 11. When the new powder layer is formed, the control unit 70 receives next cross section data from the computer 200 and forms a new cross sectional body by discharging the curable liquid onto the new powder layer and emitting ultraviolet light. In this manner, on receiving cross section data for each layer from the computer 200, the control unit 70 controls the actuator 13, the powder supply unit 20, the flattening mechanism 30, the head unit 50, and the curing energy applying unit 60 so as to form a cross sectional body for each layer, and consecutively laminates cross sectional bodies in the +Z direction, thereby modeling a three-dimensional object.

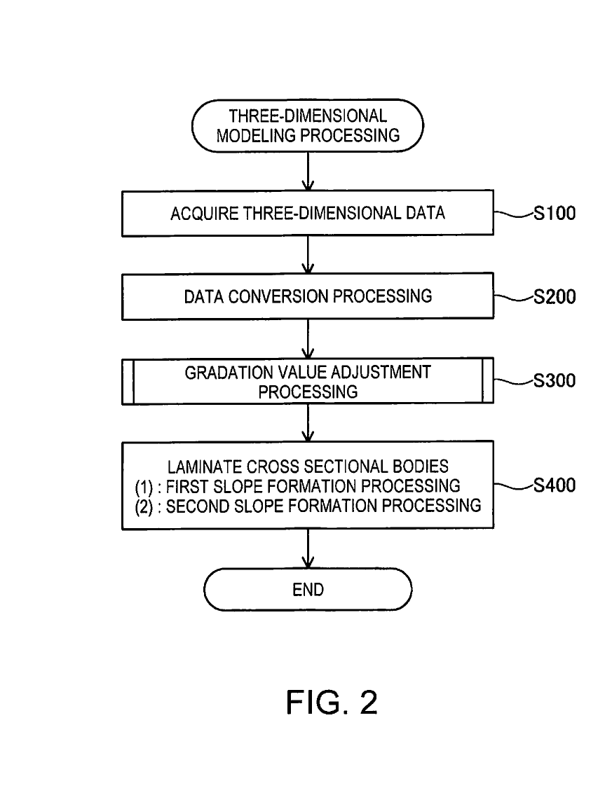

FIG. 2 is a flowchart of three-dimensional modeling processing executed by the computer 200 and the three-dimensional modeling apparatus 100. When the three-dimensional modeling processing is started, the computer 200 first acquires three-dimension data indicating the shape of a three-dimensional object from a recording medium, another device on a network or an application program or the like being executed on the computer 200 (step S100). The three-dimensional data is represented by three-dimensional polygon data, two-dimensional bitmap data for each cross section, or two-dimensional vector data for each cross section, for example. In this embodiment, assume that the three-dimensional data is represented by polygon data, which is a set of polygons.

Upon obtaining the three-dimensional data, the computer 200 performs data conversion processing (step S200). In this data conversion processing, the three-dimensional data represented by polygon data, that is, three-dimensional data in a vector format is converted into three-dimensional data in a raster format. This data conversion processing is performed using a known image processing technique for converting vector data into raster data. In this data conversion processing, the conversion is performed such that resolutions of two-dimensional bitmap data in the X direction, the Y direction, and the Z direction after the conversion are the same as the modeling resolution of the three-dimensional object. Therefore, one coordinate in the three-dimensional data after the conversion corresponds to one unit grille that is a minimum unit for the modeling. Cross sectional data (bitmap data) for each layer is obtained by slicing the three-dimensional data in a raster format in accordance with the lamination pitch in the Z direction (=modeling resolution in the Z direction).

When the data conversion processing ends, the computer 200 performs gradation value adjustment processing (step S300). This gradation value adjustment processing is processing for adjusting the gradation values in. the three-dimensional data in order to suppress the formation of a level difference in a slope portion of the upper surface or the lower surface of the object, when modeling the object.

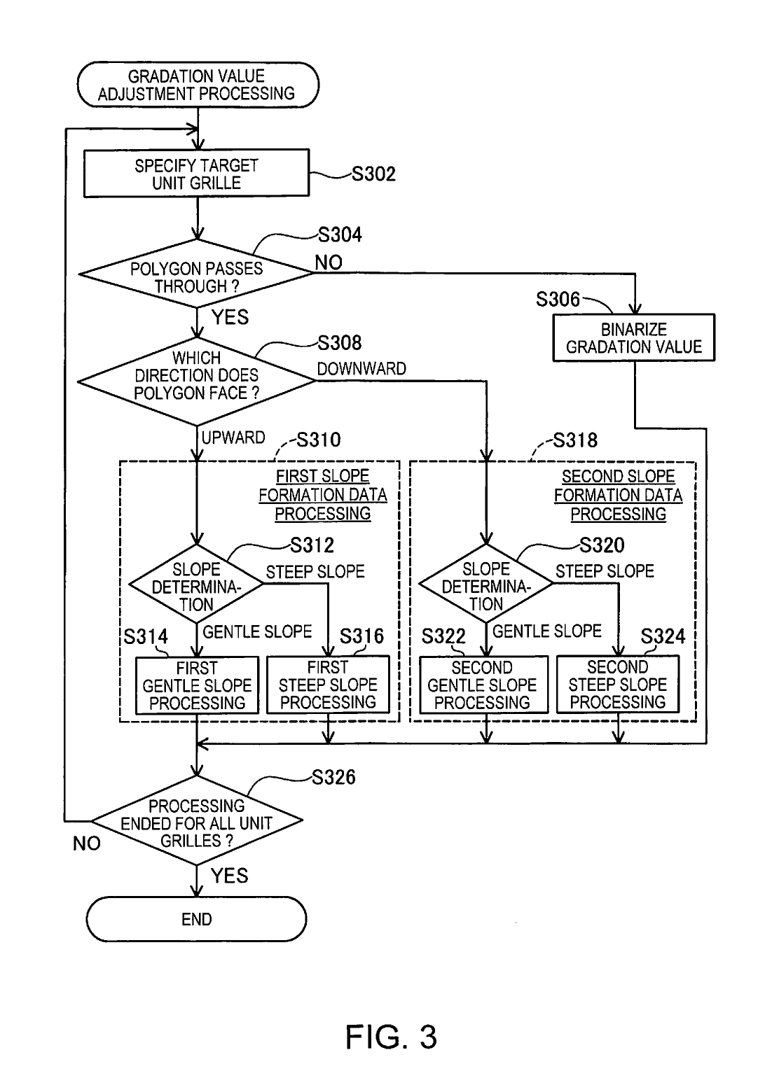

FIG. 3 is a detailed flowchart of the gradation value adjustment processing. When this gradation value adjustment processing is started, the computer 200 first designates a unit grille in which a gradation value is to be adjusted in the three-dimensional data in a raster format (step S302). Hereinafter, the unit grille designated in this processing is referred to as “target unit grille”.

When the target unit grille is designated, the computer 200 determines whether or not a polygon traverses the target unit grille (step S304). In this embodiment, a polygon traversing a unit grille means a polygon traversing at least three out of the six side surfaces constituting the unit grille. In the case where a polygon does not traverse the target unit grille (step S304: NO), the computer 200 binarizes the gradation value of the target unit grille (step S306).

In the above step S306, specifically, if the target unit grille is within the object, the computer 200 associates the target unit grille with a forming ink gradation value of 100%. In addition, if the target unit grille is outside the object, the computer 200 associates the target unit grille with a supporting ink gradation value of 100%. In other words, in step S306, the gradation value that is associated with the unit grille is either the forming ink gradation value of 100%, or the supporting ink gradation value of 100%.

In the above step S304, if it is determined that a polygon traverses the target unit grille (step S304: YES), the computer 200 determines whether the direction that the polygon traversing the target unit grille (hereinafter referred to as “target polygon”) faces is the upper side (the +Z direction side) or the lower side (the −Z direction side) (step S308). Specifically, the computer 200 determines that the direction that the polygon faces is the upper side if the Z component of the normal vector of the target polygon is a positive value, and that the direction that the polygon faces is the lower side if the Z component of the normal vector of the target polygon is a negative value.

In the case where the direction that the target polygon faces is the upper side as a result of the determination of the above step S308, the computer 200 executes first slope formation data processing (step S310). However, in the case where the direction that the target polygon faces is the lower side, the computer 200 executes second slope formation data processing (step S318). The first slope formation data processing is processing for adjusting a gradation value in order to form a slope on the upper surface side of the object. The second slope formation data processing is processing for adjusting a gradation value in order to form a slope on the lower surface side of the object.

When starting the first slope formation data processing, the computer 200 first determines whether the slope state of the target polygon is a steep slope or a gentle slope (slope determination) (step S312). In the first slope formation data processing, in the case where a first steep slope condition that the target polygon crosses the upper surface and lower surface of the target unit grille is satisfied, the computer 200 determines that the target polygon is a steep slope. However, in the case where the relationship between the target polygon and the target unit grille does not satisfy the above first steep slope condition, the computer 200 determines that the target polygon is a gentle slope.

In the above step S312, if it is determined that the target polygon is a gentle slope, the computer 200 executes first gentle slope processing (step S314). On the other hand, in the case where it is determined that the target polygon is a steep slope, the computer 200 executes first steep slope processing (step S316).

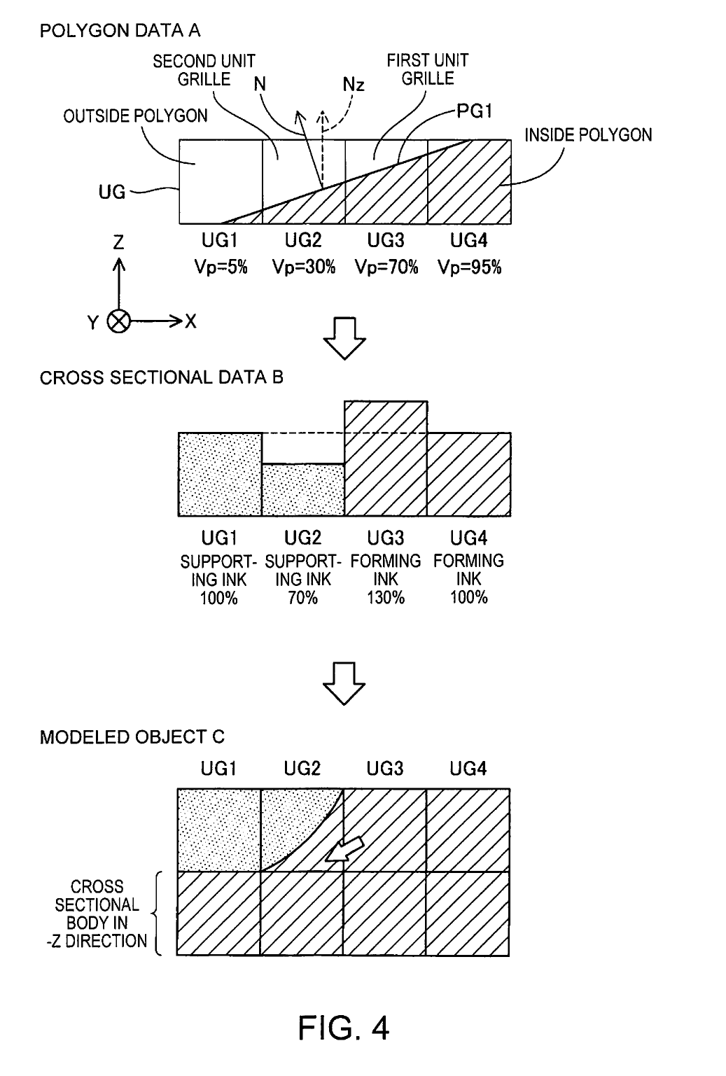

FIG. 4 is a diagram for describing the processing content of the first gentle slope processing. Polygon data A in FIG. 4 indicates four unit grilles UG1, UG2, UG3, and UG4 (also referred to as unit grilles UG) that are consecutively adjacent to each other in the X direction of the XY plane, and a polygon PG1 passes through the four unit grilles UG1, UG2, UG3, and UG4. Assume that the polygon PG1 is perpendicular to the XZ plane. The Z component Nz of the normal vector N of the polygon PG1 is a positive value, and therefore the direction that the polygon PG1 shown in the polygon data A faces is the upper side. Residual volumes Vp of the four unit grilles UG1, UG2, UG3, and UG4 aligned from the −X side to +X side are respectively 5%, 30%, 70%, and 95% in the case of being cut through by the polygon PG1. Note that the polygon PG1 can correspond to the “first polygon”.

In the first gentle slope processing, if the target unit grille (in the case of FIG. 4, the unit grille UG3) is the unit grille that is the outermost in the X direction or the Y direction among the unit grilles in which the residual volume Vp is greater than or equal to a predetermined threshold (in this embodiment, 50%), the computer 200 associates the target unit grille with a forming ink gradation value that exceeds 100%. The unit grille in which the forming ink gradation value is adjusted is referred to as “first unit grille”. In the first gentle slope processing, the computer 200 associates the first unit grille with a value obtained by adding 100% to the value of the residual volume Vp of a second unit grille that is outward of and adjacent to the first unit grille in the X direction or the Y direction (in the case of FIG. 4, the unit grille UG2) (30%), as the forming ink gradation value of the first unit grille. Therefore, the unit grille UG3 shown in the polygon data A in FIG. 4 is associated with a forming ink gradation value of 130%, as shown in cross sectional data B in FIG. 4.

In the first gentle slope processing, the computer 200 further associates the second unit grille adjacent to the first unit grille with a supporting ink gradation value that is less than or equal to 100%. Specifically, the computer 200 associates the second unit grille with a value obtained by subtracting the residual volume Vp of the second unit grille from 100%, as the supporting ink gradation value for the second unit grille. Therefore, the unit grille UG2 shown in the polygon data A in FIG. 4 is associated with a supporting ink gradation value of 70%, as shown in the cross sectional data B in FIG. 4. Note that the computer 200 compares the magnitudes of the X component and Y component of the normal vector N of the target polygon, and designates a unit grille adjacent in the direction of the larger component as the second unit grille out of the unit grilles that are outward of and adjacent to the first unit grille in the X direction and the Y direction.

In this first gentle slope processing, the computer 200 associates the unit grille UG4 that is inward of the unit grille UG3 (first unit grille) in the X direction or the Y direction with a forming ink gradation value of 100%, regardless of the value of the residual volume Vp of the unit grille UG4. The computer 200 also associates the unit grille UG1 that is outward of the unit grille UG2 (second unit grille) in the X direction or the Y direction with a supporting ink gradation value of 100%, regardless of the value of the residual volume Vp of the unit grille UG1.

The cross sectional data B in FIG. 4 shows the gradation values of the unit grilles UG that were determined by performing the first gentle slope processing as described above. When a three-dimensional object is modeled by the three-dimensional modeling apparatus 100 based on the gradation values shown in this cross sectional data B, the forming ink flows from the unit grille UG3 associated with a forming ink gradation value that exceeds 100% into the unit grille UG2 associated with a supporting ink gradation value that is less than 100%, as shown in a modeled object C. Then, due to the forming ink flowing under the supporting ink due to gravity, the formation of a level difference in a gentle slope on the upper side of the object is suppressed. In other words, in the first gentle slope processing, the gradation values of the first unit grille and the second unit grille are individually adjusted such that a slope is formed for the one unit grille UG2.

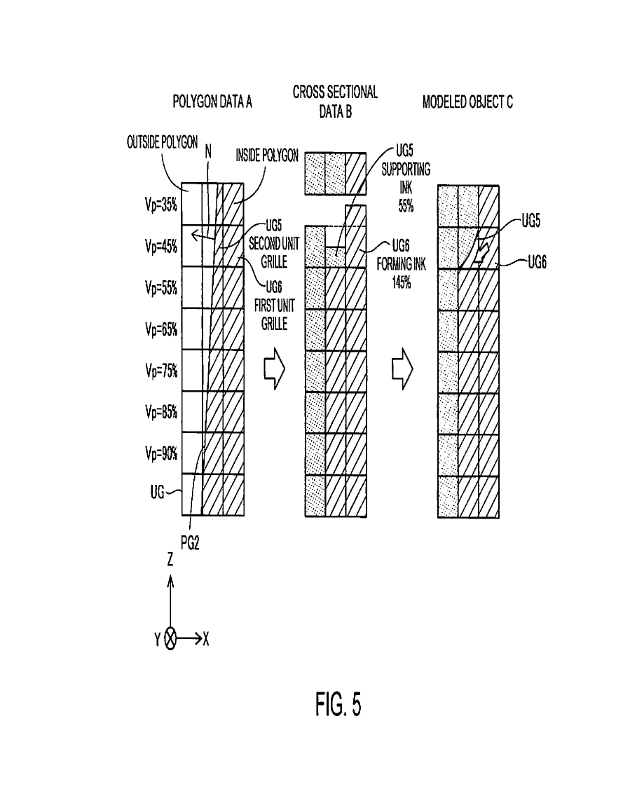

FIG. 5 is a diagram for describing the processing content of the first steep slope processing. Polygon data A in FIG. 5 indicates three unit grilles UG in the X direction and eight unit grilles UG in the Z direction, and also indicates that a polygon PG2 passes through seven unit grilles UG from the top in the center in the X direction, and a unit grille UG that is at the end on the −X direction side and is the lowermost. Assume that the polygon PG2 is perpendicular to the XZ plane. The Z component of the normal vector N of the polygon PG2 is a positive value, and therefore the direction that the polygon PG2 shown in the polygon data A faces is the upper side. The residual volumes Vp of the seven unit grilles UG from the top in the center in the X direction are 35%, 45%, 55%, 65%, 75%, 85%, and 90% in the case of being cut through by the polygon PG2. In addition, the polygon PG2 can correspond to the “second polygon”.

In the first steep slope processing, in the case where the residual volume Vp of the unit grille that is below and adjacent to the target unit grille (in the case of FIG. 5, a unit grille UG5 that is the second from the top in the center in the X direction) is greater than or equal to a predetermined threshold (in this embodiment, 50%), and the residual volume Vp of the target unit grille is less than the threshold, the computer 200 associates the unit grille that is inward of and adjacent to the target unit grille in the X direction or the Y direction (in the case of FIG. 5, a unit grille UG6 that is the second from the top on the +X direction side) with a forming ink gradation value that exceeds 100%. Similarly to the first gentle slope, the unit grille in which the forming ink gradation value is adjusted is referred to as the “first unit grille”.

In the first steep slope processing, the computer 200 associates the first unit grille (in the case of FIG. 5, the unit grille UG6) with a value obtained by adding 100% to the value of the residual volume Vp of the target unit grille (45%), as a forming ink gradation value of the first unit grille. Therefore, the unit grille UG6 shown in the polygon data A in FIG. 5 is associated with a forming ink gradation value of 145%, as shown in cross sectional data B in FIG. 5.

In the first steep slope processing, the computer 200 further associates a supporting ink gradation value that is less than 100% with the second unit grille that is adjacent to the first unit grille and was the basis for the adjustment of the gradation value of the first unit grille. Specifically, the computer 200 associates the above second unit grille with a value obtained by subtracting the residual volume Vp of the second unit grille from 100%, as the supporting ink gradation value of the second unit grille. Therefore, the unit grille UG5 shown in the polygon data A is associated with a supporting ink gradation value of 55%, as shown in the cross sectional data B. Note that the computer 200 compares the magnitudes of the X component and Y component of the normal vector N of the target polygon, and designates, out of the unit grilles that are inward of and adjacent to the target unit grille (the second unit grille) in the X direction and the Y direction, the unit grille that is adjacent in the direction of the larger component as the first unit grille.

In this first steep slope processing, the computer 200 associates the unit grille that is above and adjacent to the second unit grille with a supporting ink gradation value of 100%, regardless of the value of the residual volume Vp of the unit grille. In addition, a unit grille whose residual volume Vp is greater than or equal to a threshold (in this embodiment, 50%) is associated with a forming ink gradation value of 100%. The cross sectional data B shows the gradation values of the unit grilles UG that were determined by performing the first steep slope processing as described above. When a three-dimensional object is modeled by the three-dimensional modeling apparatus 100 based on the gradation values shown in this cross sectional data B, the forming ink flows from the unit grille UG6 that is associated with a forming ink gradation value that exceeds 100%, into the unit grille UG5 that is associated with a supporting ink gradation value that is 100% or less, as shown in a modeled object C. Then, due to the forming ink flowing under the supporting ink due to gravity, the formation of a level difference in a steep slope on the upper side of the object is suppressed. In other words, in the first steep slope processing as well, similarly to the first gentle slope processing, the gradation values of the first unit grille and the second unit grille are individually adjusted such that a slope is formed in the one unit grille UG5.

Here, description will be given with reference to FIG. 3 again. In the case where the direction that the target polygon faces is the lower side according to the determination in the above step S308, the computer 200 executes the second slope formation data processing (step S318). When starting the second slope formation data processing, the computer 200 first determines whether the state of the slope of the target polygon is a steep slope or a gentle slope (slope determination) (step 8320). In the second slope formation data processing, in the case where a second steep slope condition that the target polygon passes through the upper surface and the lower surface of the target unit grille is satisfied, the computer 200 determines that the target polygon is a steep slope. However, in the case where the relationship between the target polygon and the target unit grille does not satisfy the above second steep slope condition, the computer 200 determines that the target polygon is a gentle slope. Note that in this embodiment, the first steep slope condition and the second steep slope condition are the same.

In the above step S320, in the case where it is determined that the target polygon is a gentle slope, the computer 200 executes the second gentle slope processing (step S322). However, in the case where it is determined that the target polygon is a steep slope, the computer 200 executes second steep slope processing (step S324).

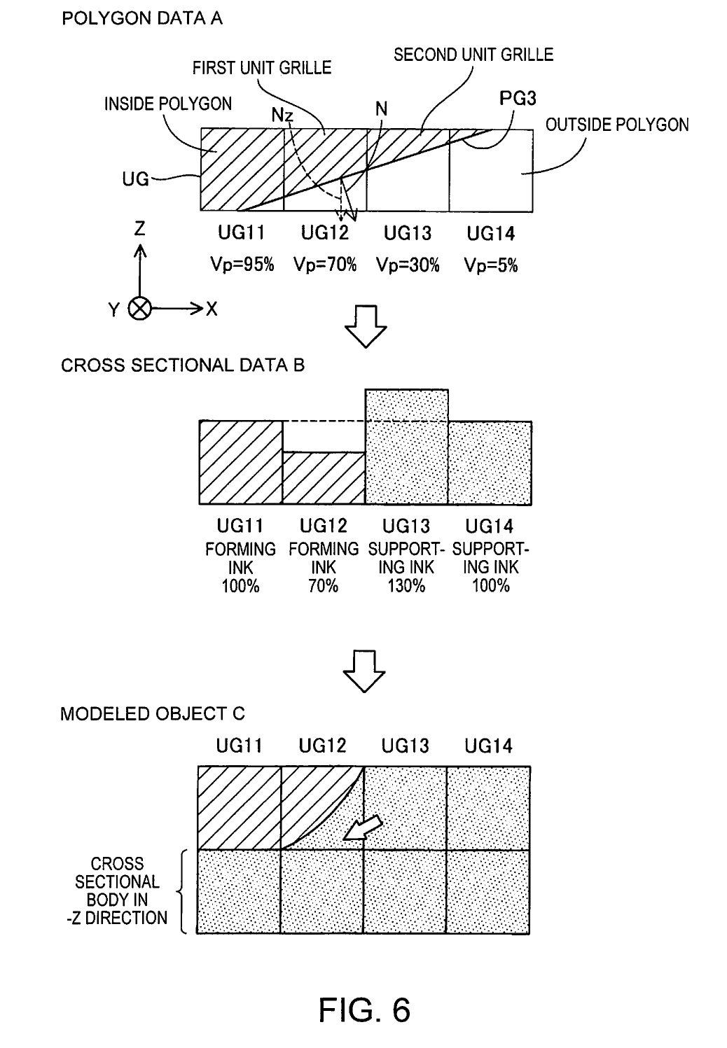

FIG. 6 is a diagram for describing the processing content of the second gentle slope processing. Polygon data A in FIG. 6 indicates four unit grilles UG11, UG12, UG13, and UG14 (also referred to as unit grilles UG) consecutively adjacent in the X direction of the XY plane, and also indicates that a polygon PG3 passes through the four unit grilles UG. Assume that the polygon PG3 is perpendicular to the XZ plane. The Z component Nz of the normal vector N of the polygon PG3 is a negative value, and therefore the direction that the polygon PG3 shown in the polygon data A faces is the lower side. In the case of being cut through by the polygon PG3, the residual volumes Vp of the four unit grilles UG11, UG12, UG13, and UG14 aligned sequentially from the −X side to the +X side are respectively 95%, 70%, 30%, and 5%. Note that the polygon PG3 can correspond to the “first polygon”.

In the second gentle slope processing, in the case where the target unit grille (in the case of FIG. 6, the unit grille UG12) is the outermost unit grille in the X direction or the Y direction among the unit grilles that have a residual volume Vp that is greater than or equal to a predetermined threshold (in this embodiment, 50%), the computer 200 associates the target unit grille with a forming ink gradation value that is less than 100%. In the second gentle slope processing as well, the unit grille in which a forming ink gradation value is adjusted is referred to as the “first unit grille”. In the second gentle slope processing, the first unit grille is associated with the value of the residual volume Vp of the first unit grille that is unchanged, as a forming ink gradation value. Therefore, the unit grille UG12 shown in the polygon data A in FIG. 6 is associated with a forming ink gradation value of 70%, as shown in cross sectional data B in FIG. 6.

In the second gentle slope processing, the computer 200 further associates a supporting ink gradation value that exceeds 100% with the second unit grille that is outward of and adjacent to the first unit grille in the X direction or the Y direction (the unit grille UG13 in the polygon data A in FIG. 6). Specifically, the computer 200 associates the second unit grille with a value obtained by adding 100% to the value of the residual volume Vp of the second unit grille, as the supporting ink gradation value of the second unit grille. Therefore, the unit grille UG13 shown in the polygon data A in FIG. 6 is associated with a supporting ink gradation value of 130% as shown in the cross sectional data B in FIG. 6. Note that the computer 200 compares the magnitudes of the X component and Y component of the normal vector N of the target polygon, and designates the unit grille that is adjacent in the direction of the larger component out of the unit grilles that are outward of and adjacent to the first unit grille in the X direction and the Y direction, as the second unit grille.

In this second gentle slope processing, the computer 200 associates the unit grille UG11 that is inward of and adjacent to the unit grille UG12 (first unit grille) in the X direction or the Y direction with a forming ink gradation value of 100%, regardless of the value of the residual volume Vp of the unit grille UG11. The computer 200 also associates the unit grille UG14 that is outward of and adjacent to the unit grille UG13 (second unit grille) in the X direction or the Y direction with a supporting ink gradation value of 100%, regardless of the value of the residual volume Vp of the unit grille UG14.

The cross sectional data B in FIG. 6 shows the gradation values of the unit grilles UG that were determined by performing the second gentle slope processing as described above. When a three-dimensional object is modeled by the three-dimensional modeling apparatus 100 based on the gradation values shown in this cross sectional data B, the supporting ink flows from the unit grille UG13 that is associated with a supporting ink gradation value that exceeds 100% into the unit grille UG12 that is associated with a forming ink gradation value that is less than 100%, as shown in a modeled object C. Accordingly, due to the supporting ink flowing under the forming ink due to gravity, the formation of a level difference in a gentle slope on the lower side of the object is suppressed. In other words, in the second gentle slope processing as well, similarly to the first gentle slope processing, the gradation values of the first unit grille and the second unit grille are individually adjusted such that a slope is formed on the one unit grille UG12.

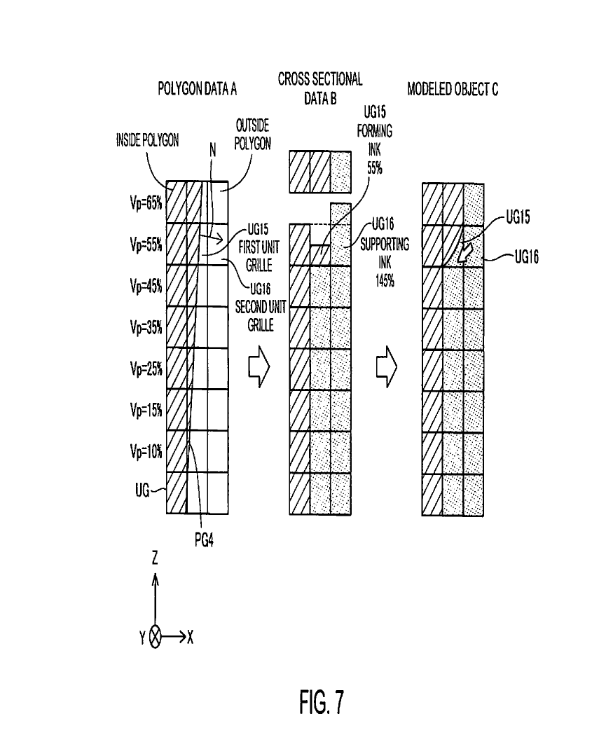

FIG. 7 is a diagram for describing the processing content of the second steep slope processing. Polygon data A in FIG. 7 indicates three unit grilles UG in the X direction and eight unit grilles UG in the Z direction, and also indicates that a polygon PG4 passes through seven unit grilles UG from the top in the center in the X direction, and a unit grille UG that is at the end on the −X direction side and is the lowermost. Assume that the polygon PG4 is perpendicular to the XZ plane. The Z component of the normal vector N of the polygon PG4 is a negative value, and thus the direction that the polygon PG4 shown in the polygon data A faces is the lower side. The residual volumes VP of seven unit grilles UG from the top in the center in the X direction are 65%, 55%, 45%, 35%, 25%, 15%, and 10% in the case of being cut through by the polygon PG4. Note that the polygon PG4 can correspond to the “second polygon.

In the second steep slope processing, in the case where the residual volume Vp of the unit grille that is below and adjacent to the target unit grille (in the case of FIG. 7, the unit grille UG15 that is the second from the top in the center in the X direction) is less than a predetermined threshold (in this embodiment, 50%), and the residual volume Vp of the target unit grille is greater than or equal to the threshold, the computer 200 associates the target unit grille with a forming ink gradation value that is less than or equal to 100%. Similarly to the first steep slope processing, the unit grille in which the forming ink gradation value ink is adjusted is referred to as the “first unit grille”.

In the second steep slope processing, the computer 200 associates the first unit grille with the value of the residual volume VP of the first unit grille (55%) that is unchanged, as a forming ink gradation value. Therefore, the unit grille UG15 shown in the polygon data A in FIG. 7 is associated with a forming ink gradation value of 55% as shown in cross sectional data B in FIG. 7.

In the second steep slope processing, the computer 200 further associates the second unit grille that is outward of and adjacent to the first unit grille in the X direction or the Y direction (the unit grille UG16 in the polygon data A in FIG. 7) with a supporting ink gradation value that exceeds 100%. Specifically, the computer 200 associates the second unit grille with a value obtained by adding 100% to a value obtained by subtracting the residual volume Vp of the first unit grille from 100%, as the supporting ink gradation value of the second unit grille. Therefore, the unit grille UG16 shown in the polygon data A is associated with a supporting ink gradation value of 145% as shown in the cross sectional data B in FIG. 7. Note that the computer 200 compares the magnitudes of the X component and Y component of the normal vector N of the target polygon, and designates, out of the unit grilles that are outward of and adjacent to the first unit grille in the X direction and the Y direction, the unit grille adjacent in the direction of the larger component as the second unit grille.

In this second steep slope processing, the computer 200 associates the unit grille that is above and adjacent to the first unit grille with a forming ink gradation value of 100%, regardless of the value of the residual volume Vp of the unit grille. In addition, a unit grille whose residual volume Vp is less than a threshold is associated with a supporting ink gradation value of 100%. The cross sectional data B in FIG. 7 shows the gradation values of the unit grilles UG that were determined by performing the second steep slope processing as described above. When a three-dimensional object is modeled by the three-dimensional modeling apparatus 100 based on the gradation values shown in this cross sectional data B, the supporting ink flows from the unit grille UG16 that is associated with a supporting ink gradation value that exceeds 100%, into the unit grille UG15 that is associated with a forming ink gradation value that is less than 100%, as shown in a modeled object C. Accordingly, due to the supporting ink flowing under the forming ink due to gravity, the formation of a level difference in a steep slope on the lower side of the object is suppressed. In other words, in the second steep slope processing as well, similarly to the first gentle slope processing, the gradation values of the first unit grille and the second unit grille are individually adjusted such that a slope is formed on the one unit grille UG 15.

Description will be given below with reference to FIG. 3 again. When either binarization in the above step S306, the first gentle slope processing in step S314, the first steep slope processing in step S316, the second gentle slope processing in step S322, or the second steep slope processing in step S324 ends with respect to the target unit grille, the computer 200 determines whether or not the above processing has ended for all the unit grilles (step S326). If the above processing has ended for all the unit grilles, the computer 200 ends the gradation value adjustment processing. However, if the above processing has not ended for all the unit grilles, the procedure is returned to step S302, and the above processing is repeated for the remaining unit grilles.

When the gradation value adjustment processing described above ends, the three-dimensional modeling apparatus 100 obtains cross sectional data for each layer from the computer 200, and models the three-dimensional object by laminating cross sectional bodies one by one using the above method (step S400 in FIG. 2). In this step S400, the control unit 70 of the three-dimensional modeling apparatus 100 controls the head unit 50 so as to execute the first slope formation processing on the first unit grille and the second unit grille in accordance with the gradation values associated with those unit grilles, which were adjusted by the above first slope formation data processing. In the first slope formation processing, as shown in the modeled object C in FIG. 4, or the modeled object C in FIG. 5, the forming ink is discharged into the first unit grille in an amount that is greater than or equal to the spatial volume of the first unit grille, and the supporting ink is discharged into the second unit grille in an amount that is less than the spatial volume of the second unit grille.

In addition, in the above step S400, the control unit 70 of the three-dimensional modeling apparatus 100 controls the head unit 50 so as to execute the second slope formation processing on the first unit grille and the second unit grille in accordance with the gradation values associated with those unit grilles, which were adjusted by performing the above second slope formation data processing. In the second slope formation processing, as shown in the modeled object C in FIG. 6, or the modeled object C in FIG. 7, the forming ink is discharged into the first unit grille in an amount that is less than the spatial volume of the first unit grille, and the supporting ink is discharged into the second unit grille in an amount that is greater than or equal to the spatial volume of the second unit grille.

Note that in the case of this embodiment for forming an object using powder, the “spatial volume” of a unit grille UG is a volume obtained by subtracting the volume of the powder included in the unit grille UG from the volume of the unit grille UG. In the case where the gradation value is 100%, the forming ink or the supporting ink is discharged such that the spatial volume is substantially filled.

According to the three-dimensional modeling apparatus 100 of this embodiment described above, the forming ink can be caused to flow from the first unit grille into which the forming ink is discharged into the second unit grille adjacent thereto in the X direction or the Y direction, or the supporting ink can be caused to flow from the second unit grille into which the supporting ink is discharged into the first unit grille adjacent thereto in the X direction or the Y direction. Therefore, a slope can be formed across the first unit grille and the second unit grille adjacent in the X direction or the Y direction. As a result, the formation of a level difference in a slope of the object is suppressed, and thereby making it possible to improve the modeling quality of the three-dimensional object.

In addition, according to this embodiment, in the case where it is determined that the first unit grille into which the forming ink is to be discharged, and the second unit grille into which the supporting ink is to be discharged are on the lamination direction side of the object (see FIGS. 4 and 5), the first slope formation processing is executed in which the forming ink is caused to flow from the first unit grille to the second unit grille. However, in the case where the first unit grille and the second unit grille are on the side opposite to the lamination direction side of the object (see FIGS. 6 and 7), the second slope formation processing is executed in which the supporting ink is cause to flow from the second unit grille to the first unit grille. Therefore, it is possible to appropriately form a slope in accordance with whether the first unit grille and the second unit grille are on the lamination direction side of the object or on the opposite side.

In addition, according to this embodiment, as shown in FIGS. 4 and 6, in the case where the same polygon passes through the first unit grille and the second unit grille, the amount of forming ink to be discharged into the first unit grille and the amount of supporting ink to be discharged into the second unit grille are determined in accordance with the residual volumes of the first unit grille and second unit grille in the case where the first unit grille and the second unit grille are cut through by that polygon. Therefore, the amount of supporting ink and the amount of forming ink for suppressing a level difference are determined in accordance with the positional relationship between the first unit grille and second unit grille and the polygon, thereby making it possible to more effectively suppress the formation of a level difference on the gentle slope.

In addition, according to this embodiment, as shown in FIGS. 5 and 7, in the case where the polygon passes through either the first unit grille or the second unit grille, the amount of forming ink to be discharged into the first unit grille and the amount of supporting ink to be discharged into the second unit grille are determined in accordance with the residual volume of the unit grille through which the polygon passes, out of the first unit grille and the second unit grille, in the case of being cut through by the polygon. Therefore, the amount of supporting ink and the amount of forming ink for suppressing a level difference are determined in accordance with the positional relationship between the polygon and the first unit grille or the second unit grille, thereby making it possible to more effectively suppress the formation of a level difference on the steep slope.

In addition, in this embodiment, in the first gentle slope processing, the first steep slope processing, the second gentle slope processing, and the second steep slope processing, the total of a forming ink gradation value to be associated with the first unit grille and a supporting ink gradation value to be associated with the second unit grille is 200%, as is obvious from FIGS. 4 to 7. Therefore, when the first slope formation processing and the second slope formation processing are executed based on these gradation values, the total of the amount of forming ink to be discharged into the first unit grille and the amount of supporting ink to be discharged into the second unit grille is the same as the total of the spatial volume of the first unit grille and the spatial volume of the second unit grille. Therefore, it is possible to uniformize the volume of the first unit grille and the volume of the second unit grille in a modeled object, thereby making it possible to improve the modeling quality of the object.

### B. Second Embodiment

In the above first embodiment, the three-dimensional data that indicates the shape of the three-dimensional object is represented by polygon data. However, in a second embodiment, the three-dimensional data is represented by bitmap data for each cross section. The configurations of the three-dimensional modeling apparatus 100 and the computer 200 in the second embodiment are the same as those in the first embodiment.

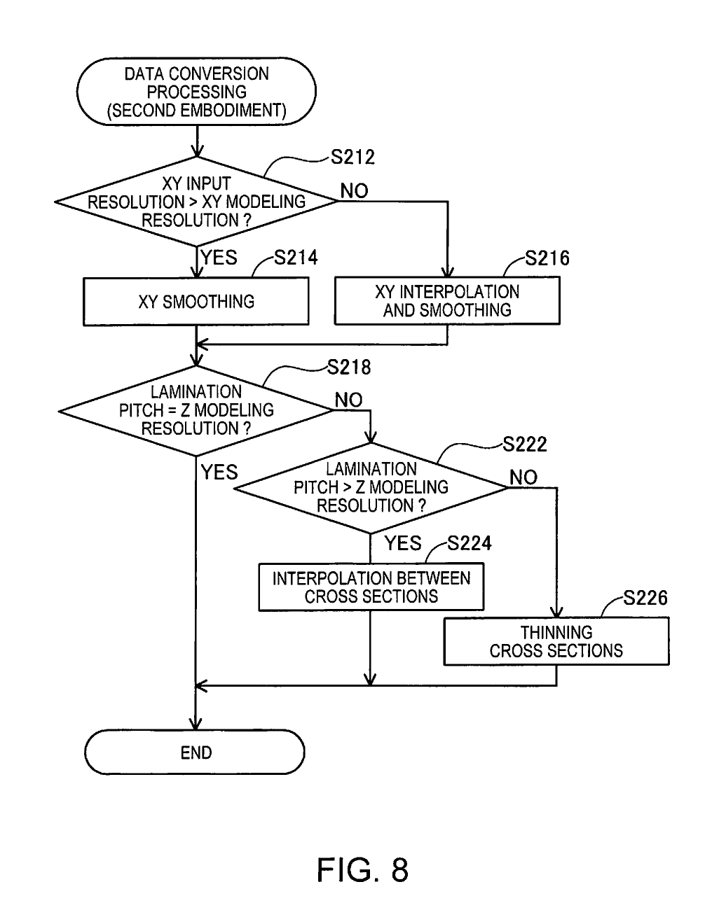

In the second embodiment, in step S100 of the three-dimensional modeling processing shown in FIG. 2, the computer 200 obtains three-dimensional data represented by bitmap data for each cross section. Subsequently, in the data conversion processing in step S200 in FIG. 2, the computer 200 executes data conversion processing shown in FIG. 8 in the second embodiment.

FIG. 8 is a flowchart of the data conversion processing in the second embodiment. In this data conversion processing, the computer 200 first compares the resolution in the XY direction of three-dimensional data (XY input resolution) and the modeling resolution in the XY direction of the three-dimensional modeling apparatus 100 (XY modeling resolution), and determines whether or not the XY input resolution is higher than the XY modeling resolution (step S212). If it is determined that the XY input resolution is higher than the XY modeling resolution (step S212: YES), the computer 200 performs general smoothing processing (XY smoothing processing) on the bitmap data for all the cross sections, such that the resolution of the bitmap data for each of the cross sections matches the XY modeling resolution (step S214). However, if it is determined that the XY input resolution is higher than the XY modeling resolution (step S212: NO), the computer 200 performs, on the bitmap data for all the cross sections, interpolation processing (XY interpolation processing) and smoothing processing, which are general image processing techniques, such that the resolution of the bitmap data for each cross section matches the XY modeling resolution (step S216).

Subsequently, the computer 200 determines whether or not the pitch in the height direction of the three-dimensional data (hereinafter, referred to as lamination pitch) matches a Z modeling resolution (hereinafter, referred to as Z resolution), which is the modeling resolution in the Z direction of the three-dimensional modeling apparatus 100 (step S218). If it is determined that the lamination pitch matches the Z resolution (step S218: YES), the computer 200 ends the data conversion processing.

In the above step S218, if it is determined that the lamination pitch does not match the Z resolution (step S218: NO), the computer 200 determines whether or not the lamination pitch is larger than the Z resolution (step S222). If it is determined that the lamination pitch is larger than the Z resolution (step S222: YES), the computer 200 performs interpolation between cross sections in accordance with the difference between the pitches so as to increase the number of cross sections, such that the lamination pitch and the Z resolution match (step S224). However, if it is determined that the lamination pitch is smaller than the Z resolution (step S222: NO), the computer 200 performs thinning on the cross sectional data so as to decrease the number of cross sections, such that the lamination pitch and the Z resolution match (step S226). When the processes of the above step S224 or step S226 are complete, the computer 200 ends the data conversion processing.

In the second embodiment, the gradation values at the outermost coordinates (unit grilles) of the object are values from 0% to 100% due to the smoothing processing performed in step S214 and step S216. In view of this, in the second embodiment, in the gradation value adjustment processing in step S300 shown in FIG. 2, the gradation values of the first unit grille and the second unit grille are adjusted based on the gradation values obtained by performing the smoothing processing rather than the residual volumes Vp shown in FIGS. 4 to 7. Note that in the second embodiment, there is no polygon, and thus the processes of step S304 and step S306 in FIG. 3 are omitted. In addition, in step S308, a surface that circumscribes the outer surface of the target unit grille is obtained, and in the case where the Z component of the normal vector of the surface is upward, the first slope formation data processing in step S310 is executed, while in the case where the Z component of the normal vector of the surface is downward, the second slope formation data processing in step S318 is executed.

According to the second embodiment described above, also in the case where the three-dimensional data is represented by bitmap data for each cross section, it is possible to suppress the formation of a level difference similarly to the first embodiment. Note that the data conversion processing in the second embodiment can be applied to fourth to sixth embodiments that will be described later.

### C. Third Embodiment

In the above second embodiment, the three-dimensional data that indicates the shape of the three-dimensional object is represented by bitmap data for each cross section. However, in a third embodiment, three-dimensional data is represented by vector data for each cross section. The configurations of the three-dimensional modeling apparatus 100 and the computer 200 in the third embodiment are the same as those in the first embodiment.

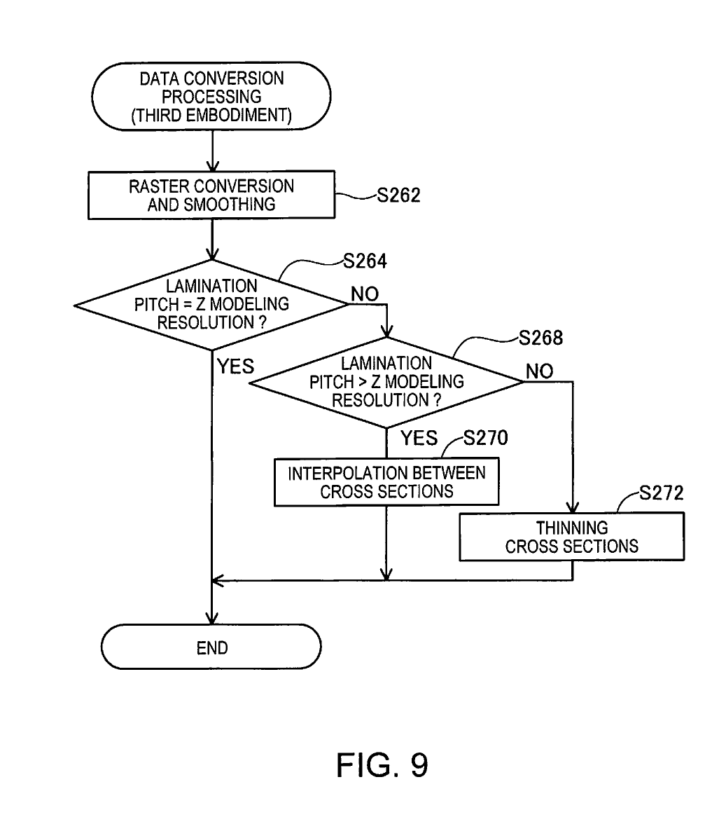

In the third embodiment, in step S100 of the three-dimensional modeling processing shown in FIG. 2, the computer 200 obtains the three-dimensional data represented by vector data for each cross section. Subsequently, in the data conversion processing of step S200 in FIG. 2, the computer 200 executes data conversion processing shown in FIG. 9, in the third embodiment.

FIG. 9 is a flowchart of the data conversion processing in the third embodiment. In this data conversion processing, the computer 200 first performs raster conversion and smoothing, which are general image processing techniques, on all the cross sections of the three-dimensional data that has been read (step S262).

When the raster conversion and the smoothing are performed, the computer 200 performs processes similar to those of steps S218, S222, S224, and S226 in the second embodiment (see FIG. 8), thereby performing interpolation of the cross sections or thinning of the cross sections (steps S264, S268, S270, and S272). When the above processes are complete, the computer 200 ends the data conversion processing.

In the third embodiment, the gradation values at the outermost coordinates (unit grilles) of the object are values from 0% to 100% due to smoothing processing performed in step S262. In view of this, in the third embodiment, in the gradation value adjustment processing in step S300 shown in FIG. 2, the gradation values of the first unit grille and the second unit grille are adjusted based on the gradation values obtained by performing smoothing processing, rather than the residual volumes Vp shown in FIGS. 4 to 7, similarly to the second embodiment.

In addition, there is no polygon in the third embodiment either, and therefore, the processes of step S304 and step S306 in FIG. 3 are omitted similarly to the second embodiment. In addition, in step S308, a surface that circumscribes the outer surface of the target unit grille is obtained, and in the case where the Z component of the normal vector of the surface is upward, the first slope formation data processing of step S310 is executed, whereas in the case where the Z component of the normal vector of the surface is downward, the second slope formation data processing of step S318 is executed.

According to the third embodiment described above, also in the case where the three-dimensional data is represented by vector data for each cross section, similarly to the above embodiments, it is possible to suppress the formation of a level difference. Note that the data conversion processing in the third embodiment can be applied to the fourth to sixth embodiments that will be described later.

### D. Fourth Embodiment

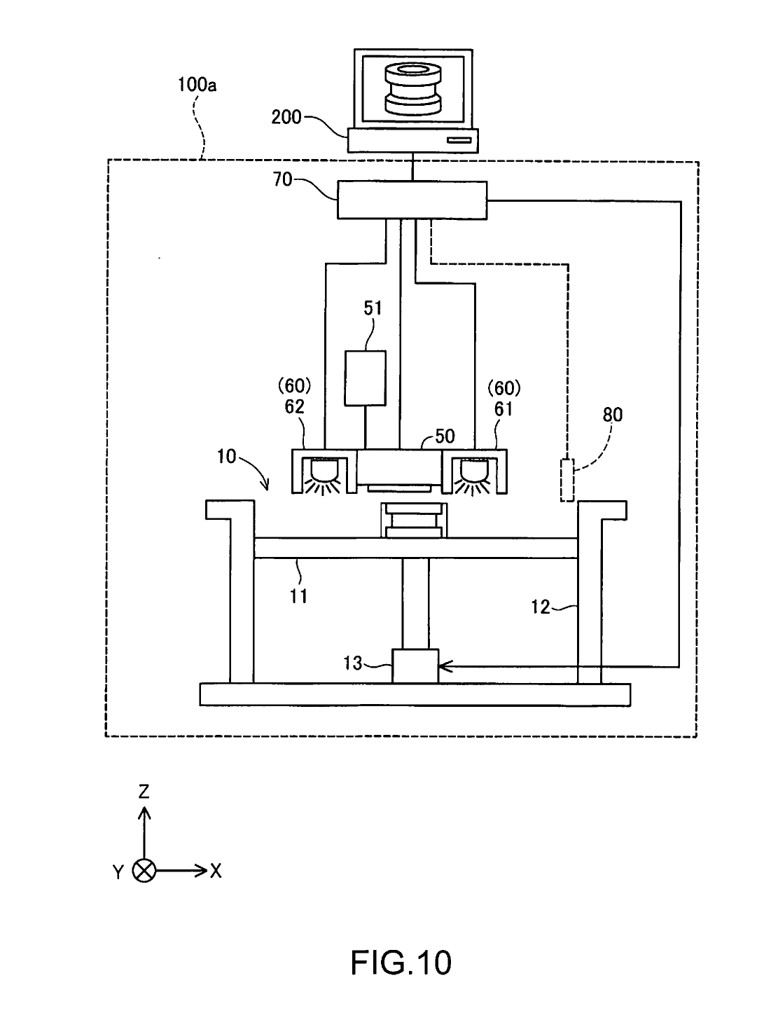

FIG. 10 is an explanatory diagram showing the schematic configuration of a three-dimensional modeling apparatus in a fourth embodiment. The three-dimensional modeling apparatus 100 of the first embodiment models a three-dimensional object by discharging a curable liquid onto powder supplied into the modeling unit 10. On the other hand, a three-dimensional modeling apparatus 100a of the fourth embodiment models a three-dimensional object using only a curable liquid containing resin, without using powder.

The three-dimensional modeling apparatus 100a is provided with the modeling unit 10, the head unit 50, the curing energy applying unit 60 and the control unit 70. The modeling unit 10 is provided with the modeling stage 11, the frame body 12 and the actuator 13 similarly to the first embodiment. However, the frame body 12 may be omitted. The tank 51 is connected to the head unit 50. The curing energy applying unit 60 is provided with the main curing light emitting apparatus 61 and the provisional curing light emitting apparatus 62. That is, the three-dimensional modeling apparatus 100a has many portions in common with the configuration of the three-dimensional modeling apparatus 100 of the first embodiment, and has a configuration in which the powder supply unit 20, the flattening mechanism 30 and the powder collecting unit 40 are omitted from the three-dimensional modeling apparatus 100 of the first embodiment.

Such a three-dimensional modeling apparatus 100a can also model a three-dimensional object by the same processing as that of the three-dimensional modeling apparatus 100 of the first embodiment, except for the processing for forming a powder layer. Note that in the case of this embodiment, no powder is used, and thus the spatial volume of the unit grille UG and the volume of the unit grille UG match. Therefore, in the case where the gradation value is 100%, the forming ink and the supporting ink are discharged such that total of the volume of the forming ink and the volume of the supporting ink match the volume of the unit grille UG

### E. Fifth Embodiment

In the above first embodiment, the formation of a level difference is suppressed by adjusting the gradation value of each of two unit grilles (the first unit grille and the second unit grille) adjacent in the X direction or the Y direction. However, in a fifth embodiment, the formation of a level difference is suppressed by discharging both the forming ink and supporting ink into one unit grille.

The configurations of the three-dimensional modeling apparatus 100 and the computer 200 in the fifth embodiment are the same as those in the first embodiment. However, in the fifth embodiment, the control unit 70 of the three-dimensional modeling apparatus 100 has a function of forming a slope of an object, which is inclined with respect to the XY plane, over a plurality of unit grilles consecutively aligned along the XY plane by gradually increasing or decreasing at least one out of the amount of forming ink and the amount of supporting ink to be discharged into the plurality of unit grilles in accordance with the positions of the unit grilles along the XY plane.

In the fifth embodiment as well, the three-dimensional modeling processing shown in FIG. 2 and the gradation value adjustment processing shown in FIG. 3 are executed by the computer 200 and the three-dimensional modeling apparatus 100. However, in the fifth embodiment, the processing content of the first gentle slope processing (step S314) and the processing content of the second gentle slope processing (step S322) in the gradation value adjustment processing shown in FIG. 3 are different from those in the first embodiment.

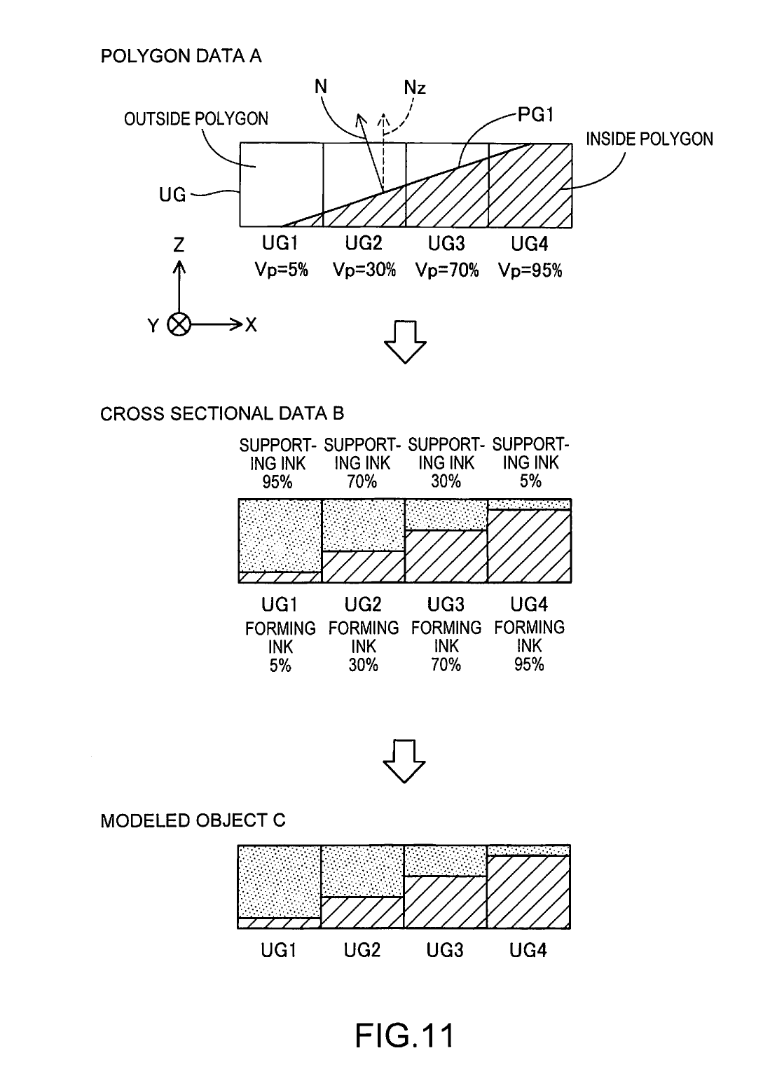

FIG. 11 is a diagram for describing the processing content of the first gentle slope processing in the fifth embodiment. Polygon data A in FIG. 11 indicates the positional relationship between four unit grilles UG consecutively aligned along the XY plane and the polygon PG1, in the same manner as the polygon data A in FIG. 4. In the example shown in the polygon data A in FIG. 11, in the case where the four unit grilles UG1, UG2, UG3, and UG4 sequentially aligned from the −X side to the +X side are cut through by the polygon PG1, the residual volumes Vp of those unit grilles are respectively 5%, 30%, 70%, and 95%, which are gradually increasing.

In this embodiment, as shown in cross sectional data B in FIG. 11, the computer 200 respectively associates the unit grilles with the values of the residual volumes Vp of the unit grilles, which have been unchanged, as forming ink gradation values for the unit grilles. The computer 200 also associates the unit grilles with values obtained by subtracting the respective values of the residual volumes Vp from 100%, as supporting ink gradation values for the respective unit grilles. Therefore, in the fifth embodiment, each of the unit grilles UG is associated with both a forming ink gradation value and a supporting ink gradation value.

In the case where each of the unit grilles UG is associated with both a forming ink gradation value and a supporting ink gradation value by performing the above first gentle slope processing, in the first slope formation processing, the control unit 70 of the three-dimensional modeling apparatus 100 controls the head unit 50 so as to first discharge the forming ink into one unit grille in an amount that is in accordance with the designated gradation value, and then discharge the supporting ink into the unit grille in an amount that is in accordance with the designated gradation value. Accordingly, the amount of forming ink and the amount of supporting ink to be discharged into each of the unit grilles UG1, UG2, UG3, and UG4 gradually decrease or increase in accordance with the positions of the unit grilles along the XY plane, and therefore, as shown in a modeled object C, it is possible to suppress the formation of an obvious level difference in a slope of the object that is inclined with respect to the XY plane.

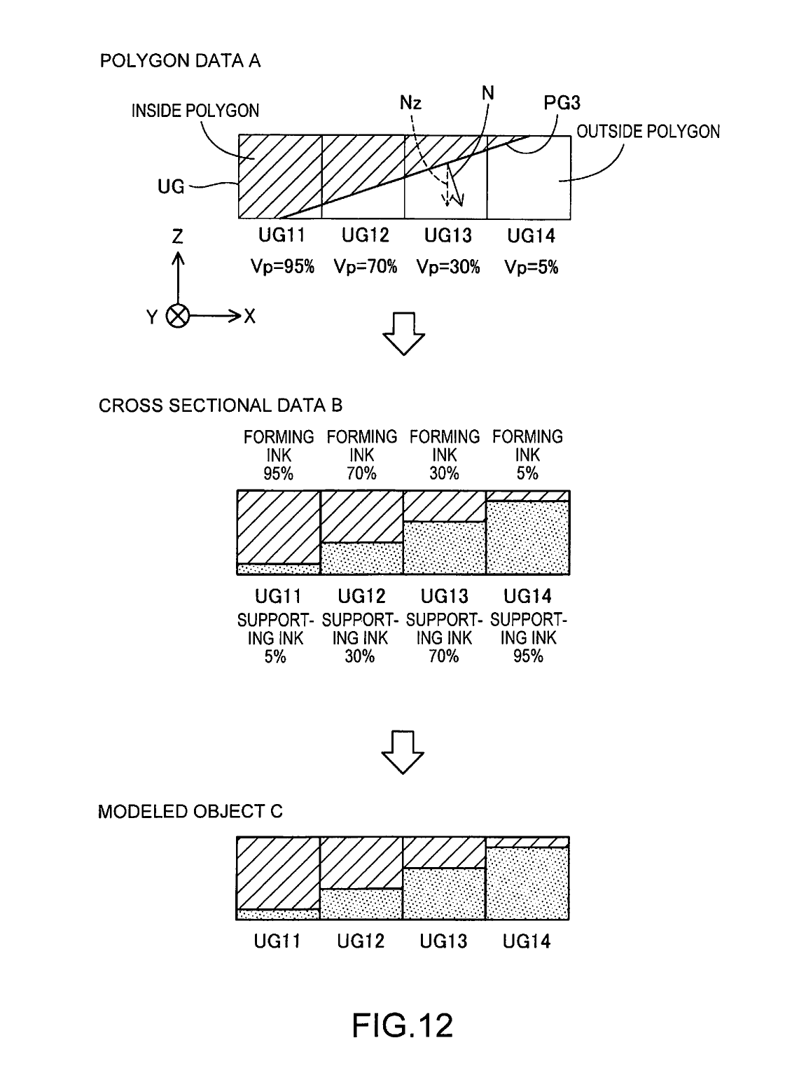

FIG. 12 is a diagram for describing the processing content of the second gentle slope processing in the fifth embodiment. Polygon data A in FIG. 12 indicates the positional relationship between four unit grilles UG consecutively aligned along the XY plane and the polygon PG3, in the same manner as the polygon data A in FIG. 6. In the example shown in the polygon data A in FIG. 12, the four unit grilles UG11, UG12, UG13, and UG14 sequentially aligned from the −X side to the +X side are cut through by the polygon PG3, and the residual volumes Vp of those unit grilles are respectively 95%, 70%, 30%, and 5%, which are gradually decreasing. In this embodiment, as shown in cross sectional data B in FIG. 12, the computer 200 associates the four unit grilles with the values of the residual volumes Vp, which have been unchanged, as forming ink gradation values for those unit grilles UG. The computer 200 also associates the four unit grilles with values obtained by subtracting the respective values of the residual volumes Vp from 100% as supporting ink gradation values of the respective unit grilles UG.

In the case where each of the unit grilles UG are associated with both a forming ink gradation value and a supporting ink gradation value by performing the above second gentle slope processing, in the second slope formation processing, the control unit 70 of the three-dimensional modeling apparatus 100 controls the head unit 50 so as to first discharge the supporting ink into one unit grille in an amount that is in accordance with the designated gradation value, and then discharge the forming ink into the unit grille in an amount that is in accordance with the designated gradation value. Accordingly, the amount of forming ink and the amount of supporting ink to be discharged into each of the unit grilles UG11, UG12, UG13, and UG14 gradually decrease or increase in accordance with the positions of the unit grilles along the XY plane. As a result, as shown in a modeled object C, it is possible to suppress the formation of an obvious level difference in the slope of the object that is inclined with respect to the XY plane.

### F. Sixth Embodiment

In the above fifth embodiment, the supporting ink gradation value and the forming ink gradation value to be associated with each of the unit grilles UG are adjusted such that the total of those gradation values is 100%. However, in a sixth embodiment, the gradation value for either the supporting ink or the forming ink is a fixed value.

The configuration of the computer 200 in the sixth embodiment is the same as that in the first embodiment. However, in the sixth embodiment, the three-dimensional modeling apparatus 100a of the fourth embodiment shown in FIG. 10 is used as the three-dimensional modeling apparatus. In other words, in the sixth embodiment, an object is modeled using only a curable liquid without using powder. The three-dimensional modeling apparatus 100a of this embodiment is provided with a cutter (cutting device) 80 such as an end mill (see FIG. 10) for cutting the upper surfaces of the cross sectional bodies.

In the sixth embodiment as well, the three-dimensional modeling processing shown in FIG. 2 and the gradation value adjustment processing shown in FIG. 3 are executed. However, in the sixth embodiment, the processing content of the first gentle slope processing (step S314) and the processing content of the second gentle slope processing (step S322) in the gradation value adjustment processing shown in FIG. 3 are different from those in the first embodiment and the fifth embodiment.

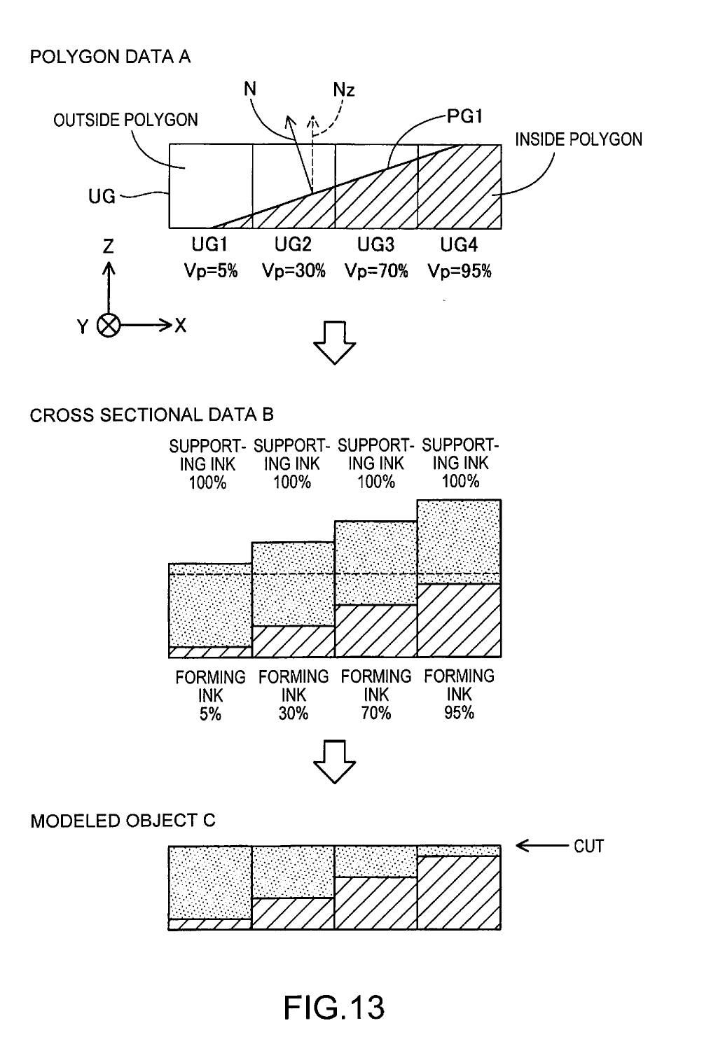

FIG. 13 is a diagram for describing the processing content of the first gentle slope processing in the sixth embodiment. Polygon data A in FIG. 13 indicates the positional relationship between four unit grilles UG consecutively aligned along the XY plane and the polygon PG1 in the same manner as the polygon data A in FIG. 11. In the example shown in the polygon data A in FIG. 13, in the case where the four unit grilles UG1, UG2, UG3, and UG4 sequentially aligned from the −X side to the +X side are cut through by the polygon PG1, the residual volumes Vp of those unit grilles are respectively 5%, 30%, 70%, and 95%, which are gradually increasing. In this embodiment, as shown in cross sectional data B in FIG. 13, the computer 200 associates the unit grilles UG with the respective values of the residual volumes Vp of those unit grilles UG, which have been unchanged, as forming ink gradation values for those unit grilles UG. The computer 200 further associates each of the unit grilles UG with a fixed gradation value (in this embodiment, 100%) as a supporting ink gradation value in addition to the forming ink gradation value. Note that the value of the fixed amount that is associated as the supporting ink gradation value may be greater than or equal to 100%, or may be less than or equal to 100% if the total of the value of the fixed amount and the minimum discharge amount of forming ink is an amount greater than or equal to 100%.

In the case where each of the unit grilles UG is associated with both a forming ink gradation value and a supporting ink gradation value by performing the above first gentle slope processing, in the first slope formation processing, the control unit 70 of the three-dimensional modeling apparatus 100a controls the head unit 50 so as to first discharge the forming ink into one unit grille UG in an amount that is in accordance with the designated gradation value, and then discharge the supporting ink into the unit grille UG in an amount that is in accordance with the designated gradation value (100%). Then, in this embodiment, as shown in cross sectional data B in FIG. 13, the supporting ink will protrude upward from the unit grille after the supporting ink is discharged. In this embodiment, after the forming ink and the supporting ink are discharged, and then a cross sectional body that is currently being formed is complete, the control unit 70 controls the cutter 80 serving as a cutting device so as to uniformly cut the cross sectional body such that the height of the cross sectional body matches the height of the lamination pitch. Accordingly, as shown in a modeled object C, the portion of the supporting ink that protrudes above the cross sectional body is removed.

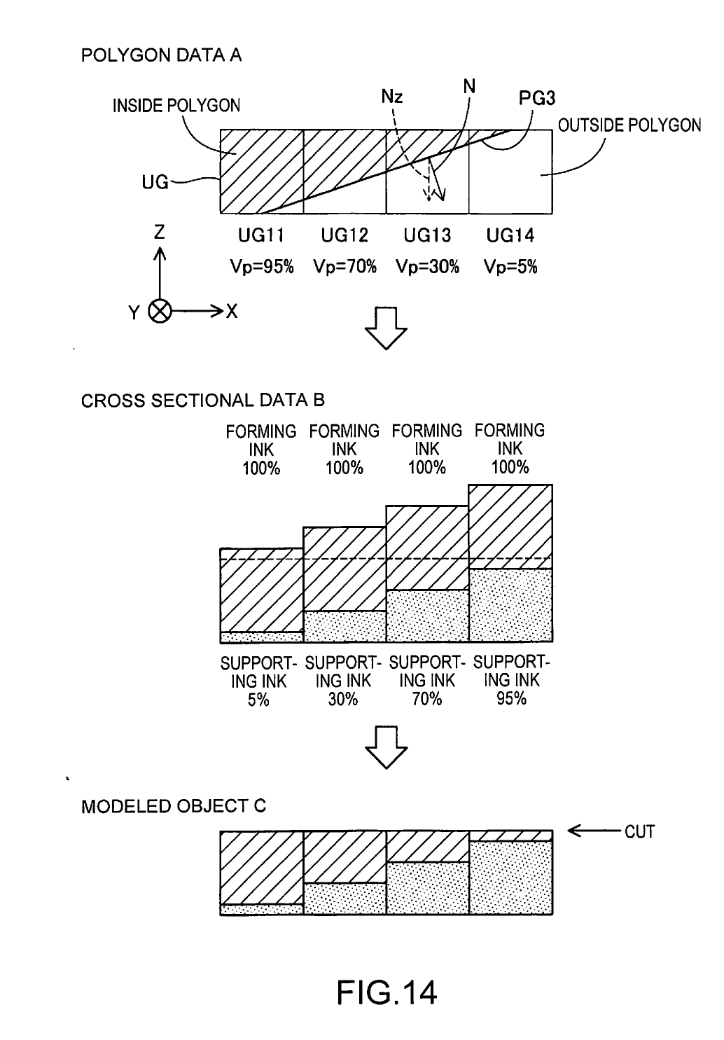

FIG. 14 is a diagram for describing the processing content of the second gentle slope processing in the sixth embodiment. Polygon data A in FIG. 14 indicates the positional relationship between four unit grilles UG continuously aligned in the XY plane and the polygon PG3 in the same manner as the polygon data A in FIG. 12. In the example shown in the polygon data A in FIG. 14, in the case where the four unit grilles UG11, UG12, UG13, and UG14 sequentially aligned from the −X side to the +X side are cut through by the polygon PG3, the residual volumes Vp of those unit grilles are respectively 95%, 70%, 30%, and 5%, which are gradually decreasing. In this embodiment, as shown in cross sectional data B in FIG. 14, the computer 200 associates those unit grilles UG with respective values obtained by subtracting the values of the residual volumes Vp of those unit grilles from 100%, as a supporting ink gradation value for those unit grilles UG. The computer 200 also associates each of the unit grilles UG with a fixed gradation value (in this embodiment, 100%) as a forming ink gradation value. Note that the value of the fixed amount that is associated as forming ink gradation value may be greater than or equal to 100%, or may be is less than or equal to 100% if the total of the value of the fixed amount and the minimum discharge amount of supporting ink is greater than or equal to 100%.

In the case where each of the unit grilles UG is associated with both a forming ink gradation value and a supporting ink gradation value by performing the above second gentle slope processing, in the second slope formation processing, the control unit 70 of the three-dimensional modeling apparatus 100a controls the head unit 50 so as to first discharge the supporting ink into one unit grille UG in an amount that is in accordance with the designated gradation value, and then discharge the forming ink into the unit grille UG in an amount that is in accordance with the designated gradation value (100%). Accordingly, in this embodiment, as shown in the cross sectional data B in FIG. 14, the forming ink will protrude upward from the unit grille, after the forming ink is discharged. In this embodiment, after the supporting ink and the forming ink are discharged, and thus a cross sectional body that is currently being formed is complete, the control unit 70 controls the cutter 80 so as to uniformly cut the cross sectional body such that the height of the cross sectional body matches the height of the lamination pitch. Accordingly, as shown in a modeled object C, the portion of the forming ink that protrudes above the cross sectional body is removed.

According to the sixth embodiment described above, it is not necessary to adjust the discharge amount of either the forming ink or the supporting ink, and therefore it is possible to reduce the processing load of at least either the three-dimensional modeling apparatus 100a or the computer 200. In addition, after each type of ink is discharged, the lamination pitches of cross sectional bodies are uniformized using the cutter 80, and thus even in the case where the discharge amount of supporting ink or forming ink cannot be adjusted, it is possible to improve the modeling quality of the ultimately modeled object while suppressing the formation of a level difference on the upper surface side and the lower surface side of the object.

### G. Modifications

Modification 1

In the above embodiments, based on the residual volumes of the unit grilles in the case of being cut through by the polygon, a forming ink gradation value and a supporting ink gradation value that are associated with the first unit grille and the second unit grille are adjusted. However, the gradation values that are associated with the first unit grille and the second unit grille may be predetermined values. For example, in the first slope formation data processing, regardless of the residual volumes Vp, the first unit grille is associated with a forming ink gradation value of 140%, and the second unit grille is associated with a supporting ink gradation value of 60%. In addition, in the second slope formation data processing, regardless of the residual volumes Vp, the first unit grille is associated with a forming ink gradation value of 60%, and the second unit grille is associated with a supporting ink gradation value of 140%. In this manner, even if the gradation values that are associated with the first unit grille and the second unit grille are predetermined values, it is possible to suppress the formation of a level difference in the upper surface or the lower surface of the object.

Modification 2

In the above embodiments, only the first slope formation data processing and the first slope formation processing, or only the second slope formation data processing and the second slope formation processing may be performed. In addition, only either the first gentle slope processing or the first steep slope processing may be performed. In addition, only either the second gentle slope processing or the second steep slope processing may be performed.

Modification 3

In the above embodiments, the discharge amounts of forming ink and supporting ink that are to be discharged from the head unit 50 may be stepwise amounts that are in accordance with the ability of the head unit 50 to adjust the ink discharge amount. Specifically, for example, when a gradation value is designated by bitmap data, the control unit 70 approximates the amount of curable liquid that corresponds to the designated gradation value to the closest amount out of predetermined types of amounts. For example, if the amount of curable liquid that can be discharged from the head unit 50 has seven types, namely, 0%, 25%, 50%, 75%, 100%, 125%, and 150%, the control unit 70 selects the amount closest to the designated gradation value from among these seven types of the amounts of curable liquid. According to this configuration as well, it is possible to suppress the formation of a level difference.

Modification 4

In the above embodiments, in the case where the discharge amount of ink of the same type to be discharged into one unit grille exceeds 100%, the discharging of a designated amount of ink may be achieved by discharging the ink into the same unit grille a plurality of times.

Modification 5

In the above embodiments, the head unit 50 relatively moves in the Z direction by the modeling stage 11 moving in the Z direction. However, the position of the modeling stage 11 may be fixed and the head unit 50 may be moved directly in the Z direction. In addition, the head unit 50 moves in the X direction and the Y direction in the above embodiments, but the position of the head unit 50 may be fixed in the X direction and the Y direction, and the modeling stage 11 may be moved in the X direction and the Y direction.

Modification 6

In the above embodiments, out of the three-dimensional modeling processes shown in FIG. 2, the acquisition of three-dimensional data in step S100, the data conversion processing in step S200, and the gradation value adjustment processing in step S300 are executed by the computer 200. However, those steps may be executed by the three-dimensional modeling apparatus 100. That is, the three-dimensional modeling apparatus 100 may execute all the processes from the acquisition of three-dimensional data to the modeling of a three-dimensional object by itself. In addition, in the above embodiments, the process of step S400 of the three-dimensional modeling processes shown in FIG. 2 is executed by the control unit 70 of the three-dimensional modeling apparatus 100. However, the process of step S400 may be executed by the computer 200 controlling the units of the three-dimensional modeling apparatus 100. That is, the computer 200 may perform the functions of the control unit 70 of the three-dimensional modeling apparatus 100.

Modification 7

In the above embodiments, the head unit 50 discharges a curable liquid in the vertical direction, however, the curable liquid maybe discharged in the horizontal direction or other directions so as to model a three-dimensional object.

The invention is not limited to the above embodiments, examples, and modifications, and can be achieved in various configurations without departing from the gist of the invention. For example, the technical features in the embodiments, examples, and modifications corresponding to the technical features in the modes can be replaced or combined as appropriate in order to solve some or all of the problems described above, or in order to achieve some or all of the aforementioned effects. Technical features that are not described as essential in the specification can be deleted as appropriate.

The entire disclosure of Japanese Patent Application No.: 2015-065916, filed Mar. 27, 2015 and 2015-065917, filed Mar. 27, 2015 are expressly incorporated by reference herein.

What is claimed is:

1. A three-dimensional modeling apparatus for modeling a three-dimensional object by laminating a plurality of cross sectional bodies in a lamination direction, the three-dimensional modeling apparatus comprising:
a head unit for modeling the object by discharging a liquid that is to be a material of the object into each unit grille that is defined in accordance with a modeling resolution of the cross sectional body in an X direction, a modeling resolution of the cross sectional body in a Y direction, and a lamination interval of the cross sectional body in the lamination direction; and
a control unit for controlling the head unit,
wherein the head unit is capable of discharging, into the unit grilles, at least one of a forming liquid for forming the object and a supporting liquid for supporting the object, and
regarding a surface of the object inclined with respect to an XY plane, in a case of discharging the forming liquid into a first unit grille and discharging the supporting liquid into a second unit grille adjacent to the first unit grille in the X direction or the Y direction, the control unit controls the head unit so as to (1) perform first slope formation processing in which the forming liquid is discharged into the first unit grille in an amount greater than or equal to a spatial volume of the first unit grille, and the supporting liquid is discharged into the second unit grille in an amount smaller than a spatial volume of the second unit grille, or (2) perform second slope formation processing in which the forming liquid is discharged into the first unit grille in an amount smaller than the spatial volume of the first unit grille, and the supporting liquid is discharged into the second unit grille in an amount greater than or equal to the spatial volume of the second unit grille.

2. The three-dimensional modeling apparatus according to claim 1,
wherein in a case where the first unit grille and the second unit grille are on a lamination direction side of the object, the control unit executes the first slope formation processing, and in a case where the first unit grille and the second unit grille are on a side in a direction opposite to the lamination direction of the object, the control unit executes the second slope formation processing.

3. The three-dimensional modeling apparatus according to claim 1,
wherein a shape of the object is indicated by polygon data that is a set of polygons, and
in a case where a first polygon passes through the first unit grille and the second unit grille, an amount of the forming liquid to be discharged into the first unit grille, and an amount of the supporting liquid to be discharged into the second unit grille are amounts individually determined in accordance with residual volumes of the first unit grille and the second unit grille in a case where the first unit grille and the second unit grille are cut through by the first polygon.

4. The three-dimensional modeling apparatus according to claim 1,
wherein a shape of the object is indicated by polygon data that is a set of polygons, and
in a case where a second polygon passes through one of the first unit grille and the second unit grille, an amount of the forming liquid to be discharged into the first unit grille, and an amount of the supporting liquid to be discharged into the second unit grille are amounts determined in accordance with a residual volume of a unit grille that the second polygon passes through, out of the first unit grille and the second unit grille, in a case of being cut through by the second polygon.

5. The three-dimensional modeling apparatus according to claim 1,
wherein in the first slope formation processing and the second slope formation processing, a total of an amount of the forming liquid to be discharged into the first unit grille and an amount of the supporting liquid to be discharged into the second unit grille is the same as a total of a spatial volume of the first unit grille and a spatial volume of the second unit grille.

6. A three-dimensional modeling apparatus for modeling a three-dimensional object by laminating a plurality of cross sectional bodies in a lamination direction, the three-dimensional modeling apparatus comprising:
a head unit for modeling the object by discharging a liquid that is to be a material of the object into each unit grille that is defined in accordance with a modeling resolution of the cross sectional body in an X direction, a modeling resolution of the cross sectional body in a Y direction, and a lamination interval of the cross sectional body in the lamination direction; and
a control unit for controlling the head unit,
wherein the head unit is capable of discharging a forming liquid for forming the object and a supporting liquid for supporting the object into one unit grille, and
the control unit gradually increases or decreases at least one of an amount of the forming liquid and an amount of the supporting liquid to be discharged into each of a plurality of unit grilles consecutively aligned along an XY plane in accordance with positions of the unit grilles along the XY plane, thereby modeling a slope of the object that is inclined with respect to the XY plane across the unit grilles.

7. The three-dimensional modeling apparatus according to claim 6,
wherein a shape of the object is indicated by polygon data that is a set of polygons, and
each of the unit grilles is associated with at least one of an amount of the forming liquid and an amount of the supporting liquid to be discharged into the unit grille in accordance with a residual volume of the unit grille in a case of being cut through by the polygon.

8. The three-dimensional modeling apparatus according to claim 6,
wherein in a case where the slope is on a lamination direction side of the object, amounts of the supporting liquid to be discharged into the plurality of unit grilles are fixed amounts.

9. The three-dimensional modeling apparatus according to claim 6,
wherein in a case where the slope is on a side in a direction opposite to the lamination direction of the object, amounts of the forming liquid to be discharged into the plurality of unit grilles are fixed amounts.

10. The three-dimensional modeling apparatus according to claim 8, further comprising a cutting device for uniformizing a height of the cross sectional body.
